(19) United States
(12) Patent Application Publication
(10) Pub. No.: US 2003/0231588 A1
(43) Pub. Date: Dec. 18, 2003

(54) Method and apparatus for multicast and unicast scheduling

(76) Inventors: Itamar Roth, Sde Warburg (IL); Tsvi Slonim, Moshav Yagel (IL); Ehud Barzilai, Meitar (IL)

Correspondence Address: NATH & ASSOCIATES, 1030 15th STREET, 6TH FLOOR, WASHINGTON, DC, 20005, US

(21) Appl. No.: 10/446,091

(22) Filed: May 28, 2003

(30) Foreign Application Priority Data
Jun. 18, 2002 (IL) 150281

(51) Int. Cl. H04L 12/28

(52) U.S. Cl. 370/230; 370/390

(57) ABSTRACT

In a method and system for scheduling unicast and multicast data packets associated a weight value reflecting the urgency of each queue in a set of available input nodes to transmit its queued cells is computed. If the highest weight queue in each input node is unicast, a request containing the weight of the queue is sent to a single output node relating to the highest weight queue. Otherwise, a request containing the weight of the queue is sent to one or more output nodes relating to the multicast queue. A grant is sent to the highest weight input node sending a request for a specific output node. Input nodes relating to unicast queues are removed from consideration in successive iterations. Input nodes relating to multicast queues may compete in successive iterations but only from the same multicast queue.

### FIELD OF INVENTION

The present invention relates to the field of communication networks, and particularly to real-time packet scheduling in packet switched networks.

### REFERENCES

In the following discussion of the prior art, reference will be made to the following publications.

[1] U.S. Pat. No. 5,267,235 “Method and Apparatus for Resource Arbitration”

[2] “Scheduling Cells in an Input Queued Switch” Nicolas McKeown's Ph.D. Thesis, University of California

[3] U.S. Pat. No. 6,212,182 “Combined unicast and multicast Scheduling”.

[4] Lee, T. T.—“Non blocking copy network for multicast packet switching”, IEEE J. Select Areas Commun., 6, 1455-1467, 1988

[5] Tuner, J. S.—“Design of a broadcast packet switching network”, IEEE Trans. Commun., 36(6), 734-743, 1988.

[6] Hwang, Shi and Yang “A High Performance multicast Switching Network based on the Cube Addressing Scheme” (Proc. Natl Sci. Counc. ROC(A), Vol. 22, No. 6, 2001. pp. 344-351).

[7] WO 01/33778 published May 10, 2001 in the name of the present applicant and entitled “Method and apparatus for high-speed, high-capacity packet-scheduling supporting quality of service in communications networks.”

[8] WO 01/65781 published Sept. 7, 2001 in the name of the present applicant and entitled “Method and apparatus for high-speed generation of a priority metric for queues.”

### BACKGROUND OF THE INVENTION

Most of the widely used traditional Internet applications operate between two computers. Examples are web browsers and email. Demand for multimedia, combining audio, video and data streams over a network, and collaborating computing is rapidly increasing. In many emerging applications, one sender transmits to a group of receivers simultaneously. This process is known generically as multipoint communications. Multipoint-based applications and services are expected to play an important role in the future of the Internet.

With multicast traffic, the data or content source sends one copy of the information to a group address, reaching all recipients who want to receive it. This technique addresses packets to a group of receivers rather than to a single receiver, and it depends on the network to forward the packets to those that need to receive them. Without multicasting, the same information must be carried over the network multiple times, one time for each recipient, using unicast traffic. This technique is simple to implement, but it has significant scaling restrictions if the group is large. Therefore, efficient multicast mechanisms deployed in the network dramatically increase the total network efficiency.

Broadband network infrastructure is coarsely composed of two basic building blocks: (1) high-speed point-to-point links and (2) high-performance network switching devices. While reliable high-speed point-to-point communications have been demonstrated using optical technologies, such as Wave Division Multiplexing (WDM), switches and routers that can efficiently manage extensive amounts of diversely characterized traffic loads are not yet available. Hence, reduction of the bottleneck of communication network infrastructures has shifted towards designing such high-performance switches and routers. These high-performance switches must support multicast traffic and use an efficient technique for switching single port incoming traffic to a group of output ports.

It is generally acknowledged that the two main goals of network switches are 1) to utilize the available internal bandwidth optimally while at the same time 2) supporting QoS requirements. Constraints derived from these goals typically contradict in the sense that maximal bandwidth utilization does not necessarily mutually correlate to the support of the most urgent traffic flows. This concept has spawned a vast range of scheduling adaptation schemes, each seeking to offer high capacity, large number of ports and low latency requirements.

One switching technique, which has become common, assumes that each input may be coupled to each potential output and that data cells to be switched, are queued at the input port while waiting for their switching. Several techniques are known for determining which input port to couple to which output port at a given time interval (“Switching time slot”).

Some scheduling disciplines use an iterative algorithm, in which one or several pairs of matching inputs and outputs are determined by the end of each iteration. The technique used for a single iteration is reapplied until all inputs and all outputs are scheduled or until another termination criterion is met . When scheduling of inputs and outputs is complete, data queued in the respective nodes are transmitted according to the schedule.

In general, the goal of a scheduling mechanism is to determine, at any given time, which queue is to be served, i.e. permitted to transfer packets to its destined output.

A common scheduling discipline practices some variation of a Virtual Output Queue's (VOQ) scheduling. In VOQ each input-node maintains a separate queue or a number of queues (in which case each queue corresponds to a distinct QoS class) for each output in the case of unicast data cells, and maintains a single or a number of multicast queues for multicast data cells. Arriving packets are classified at a primal stage to queues corresponding to the packet's designated destination and type (unicast/multicast).

Currently deployed scheduling algorithms practice some variation of a Round Robin scheme in which each queue is scanned in a cyclic manner. These schemes include deficient support of global QoS provisioning and limited scalability with respect to line speeds and port densities. These scheduling algorithms require connectivity of order N2, where N denotes the number of ports in the switch.

One problem, which has arisen in Round Robin schemes, is that the incoming cells are often an intermixed stream of unicast (destined to a single destination) and multicast cells (destined to a group of destinations). Furthermore, it is often desired to assign priorities to data cells, for Quality of Service distinguishing. Known Round Robin schemes such described in U.S. Pat. No. 5,267,235 and as described in Reference [2], do not achieve satisfactory results when the input stream of data cells intermixes both unicast and multicast data cells, each cell being prioritized with one of multiple priorities.

U.S. Pat. No. 6,212,182 discloses an example of a scheduler where each input makes two requests, being one unicast request and one multicast request, for scheduling to each output for which it has a queued data cell,. Each output grants up to one request, choosing the highest priority request first, giving precedence to one such highest priority request using an output precedence pointer, either an individual output for unicast data cells, or a group output precedence pointer which is generic to all outputs for multicast data cells. Each input accepts up to one grant for unicast data cells, or as many grants as possible for multicast data cells, choosing highest priority grants first, and giving precedence to one such highest priority grant using an input precedence pointer. As noted above, schedulers of this architecture require connectivity of order N². This method of combined scheduling of intermixed traffic types results in an even more complicated connectivity, since the unicast request lines are separate from the multicast request lines. Moreover, the decoupling of the multicast traffic scheduling mechanism (implemented as precedence pointer) from the unicast traffic scheduling mechanism (implemented as a different precedence pointers) does not fairly resolve scenarios of equal priority unicast and multicast cells destined to the same output port, rather multicast traffic usually gets strict priority over the unicast traffic.

Some other multicast switch architectures proposed previously (References [4] and [5]) are based on replicating multicast data cells in front of the routing switch. A copy network replicates cells in the number of copies requested by a given multicast connection. The copies of the cells are then routed to the desired destinations through the switch. In this manner, the routing switch and the network block can be designed independently. Clearly, there is a high probability of overflow as the total number of copies produced easily exceeds the number of output ports of the network block. Moreover, large storage elements are required to buffer copies between the network block and the switch.

Reference [6] discloses an example of a multicast scheduler based on the combination of a copy network and a cube switch. Employing the concept of cubes as the addressing scheme, the output addresses of a multicast cell are first replicated into the number of cubes by means of a copy network, instead of the number of output addresses. Thereafter, the replicated cubes are fed to the proposed non-blocking cube switch, which routes the cubes to the output addresses of the multicast connection. Thus, the number of copies in the copy network can be reduced in the multicast cell, thereby reducing the probability of cell loss in the copy network. Additionally, the memory requirement is reduced. The non-blocking switching network for cubes is composed of a Batcher-Banyan network and a broadcast Banyan switch. Nevertheless, although this multicast switching reduces the number of replications, it still requires wider bandwidth and additional buffers, since a replication to a certain extent is performed. Moreover, the hardware logic space requires to implement the cube addressing decoding is large.

Reference [7] describes a scheduler for unicast scheduling. A priority value is associated with each queue in each input-node, and a snapshot is taken of queue priorities. Sets of available input-nodes and available output-nodes are received which may initially contain all input-nodes and output-nodes, respectively, and a subset (ONS) of the set of available output-nodes is selected. For each input-node one offer is submitted containing an identity of an offered output-node in the ONS and a corresponding priority value. Offers are grouped according to the identity of the offered output-node, and the output-node associated with each group is matched with the input-node having the highest priority offer in the respective group. The matches are accumulated and matched input- and output-nodes are removed from the respective sets of available input- and output-nodes, the whole process being repeating as required.

Queue Prioritization:

Many scheduling disciplines make use of a weight metric assigned to each queue. Higher weight queues are usually more likely to be served before lower priority ones. The method used to determine the weight value for queues can thus greatly affect the overall performance of any scheduling discipline that employs weight metric.

Fairness:

To maintain scheduling fairness, it is necessary that an identical weight generating mechanism be applied to all queues. Despite this requirement for fairness, it is sometimes desirable to give inherent service preference to specific queues over other queues.

### SUMMARY OF THE INVENTION

It is therefore an object of the present invention to provide a method and apparatus for a high performance, efficient scheduling of combined unicast and multicast traffic in packet-switched networks, which operates well with prioritized data cells, while maintaining QoS provisioning and scheduling fairness for all traffic types.

It is another object of the invention to provide a method and apparatus for the scheduling of data in packet-switched networks, wherein the connectivity complications are reduced.

Other objects and advantages of the invention will become apparent following the following description of a specific embodiment.

These objects are realized in accordance with a first aspect of the invention by a method for scheduling data packets transported from input-nodes to output-nodes said data packets being associated with a set of N input-nodes each having a plurality of M queues each for queuing data packets for routing to one or more corresponding M output-nodes, said method comprising:

(a) receiving sets of available input-nodes and available output-nodes which may contain all input-nodes and output-nodes, respectively;

(b) for each queue in the set of available input nodes generating a weight value reflecting the urgency of the specified queue to transmit its queued cells;

(c) determining a highest weight queue in each input node in the set of available input nodes being the queue with the highest weight;

(d) if the highest weight queue is a unicast queue, sending a request containing the weight of the queue to a single output node relating to the highest weight queue;

(e) if the highest weight queue is a multicast queue, sending a request containing the weight of the queue to one or more output nodes relating to the multicast queue;

(f) in respect of each output node receiving requests from one or more input nodes:

i) determining a highest weight input node being the input node having the highest weight queue of those input nodes from which a request was received;

ii) sending a grant to the highest weight input node;

iii) removing the output node from consideration in successive iterations;

iv) if the highest weight input node relates to a unicast queue, removing the highest weight input node from consideration;

v) if the highest weight input node relates to a multicast queue, allowing the highest weight input node to continue sending requests for other output nodes in successive iterations but only from said multicast queue; and

(g) repeating (b) to (f) as required.

A scheduler operating according to such a method is partitioned into input nodes, scheduler core, and output nodes. Input nodes are assigned with input ports or input sub ports, whereas output nodes are assigned with output ports or output sub ports.

The present invention practices a VOQ (Virtual Output Queue) based discipline. For unicast traffic, a single VOQ is an input queue which is associated with a certain output queue and a QoS (Quality of Service) class. For multicast traffic, a VOQ is associated with a QoS class, a multicast destination group, a subset of a multicast destination group, or any combination of them. Each input node keeps track of the VOQ's status, and determines a weight for it. Each quartet defining an input node, output node, weight, and type of traffic is defined as an ‘offer’.

The scheduler core uses an iterative algorithm, where, during each iteration, it presents an ONS (Output Node Set) to the input nodes, and receives offers from each input node for a single output node in the ONS.

To generate the offer, every input port monitors its VOQs and determines a Subset of the Potential Offers (SPO) having a destination which is a member of the ONS. The SPO includes requests from both unicast and multicast VOQs. However, for each unicast VOQ, only a single offer for one output node may be requested; whereas for multicast VOQ, offers for more than one output node may be made. The input node offer to the scheduler core includes the highest-weighted offer from the SPO.

In the scheduler core, all the offers for each output node are compared and the highest weight request receives a grant, notifying the input node that a input-output match was determined.

In a similar manner to the prior-art, such as described in above-mentioned U.S. Pat. No. 6,212,182, by the end of each iteration one or more input nodes receives grants for one of its VOQs. In the case where the VOQ is of unicast type, the input port does not participate (is removed from consideration) in the following scheduling iterations, since a match of source-destination was determined. In the case of multicast queue, it can be assigned with one or more destinations in each iteration, and can participate in the following scheduling iterations as well. This is due to the fact that a single multicast source is destined to several destinations. An output node that was requested, on the other hand, does not participate in the following iterations, since it was matched with a source node. The technique used for a single iteration is reapplied until a termination criterion is met.

### BRIEF DESCRIPTION OF THE DRAWINGS

FIG. 1 shows pictorially a unicast and multicast scheduler according to the invention;

FIG. 2 is a block diagram showing functionally the architecture of the scheduler shown in FIG. 1;

FIG. 3 is a flow diagram showing the principal steps performed by the scheduler shown in FIG. 2; and

FIG. 4 is a flow diagram showing the principal steps performed by the input node for generating an offer.

### DESCRIPTION OF SPECIFIC EMBODIMENTS

Overview of scheduling discipline

In the present scheduling discipline, unicast and multicast data cells are received by the input nodes and are stored in a VoQ: Each unicast data cell, with a certain QoS, destined to a particular output node is queued in a unicast queue of the same QoS, directed to that output node. Since multicast data cells are targeted for more than one output node, they are queued in separate queues from the unicast data cells, depending on their QoS.

The method for scheduling is of an iterative nature, where each iteration consists of the following stages:

1. For each queue (unicast and multicast), the input node generates a weight value, which reflects the urgency of the specified queue to transmit its queued cells.

2. Each input node compares the weights of its queues and determines the queue with the highest weight. The input node sends a request to the output node of the highest weight queue. In the case where a multicast queue has the highest weight, a request is sent to one or more of the destinations from the multicast group. The request contains the weight of the queue.

3. Each output node receives requests from zero, one or more input nodes. The output node compares the weights of the different requests and determines the input node having the highest weight of those input nodes from which it received a request.

4. The output node sends a grant to the input node that has sent the request with the highest weight. The output node is then removed from consideration in successive iterations. In the case where the request originated from a unicast queue, the input node is also removed from consideration. On the other hand, in the case where the request originated from a multicast queue, the input node is allowed to continue sending requests for other output nodes in successive iterations but its request will be from the already once granted multicast queue. This way, by the end of the iterations a single input node is scheduled to transmit multicast data cells to a plurality of output nodes.

The technique used for a single iteration, is reapplied until all inputs or all outputs are scheduled or until another termination criterion is met. When scheduling terminates, data cells are transmitted according to the schedule.

Unicast and Multicast Scheduler

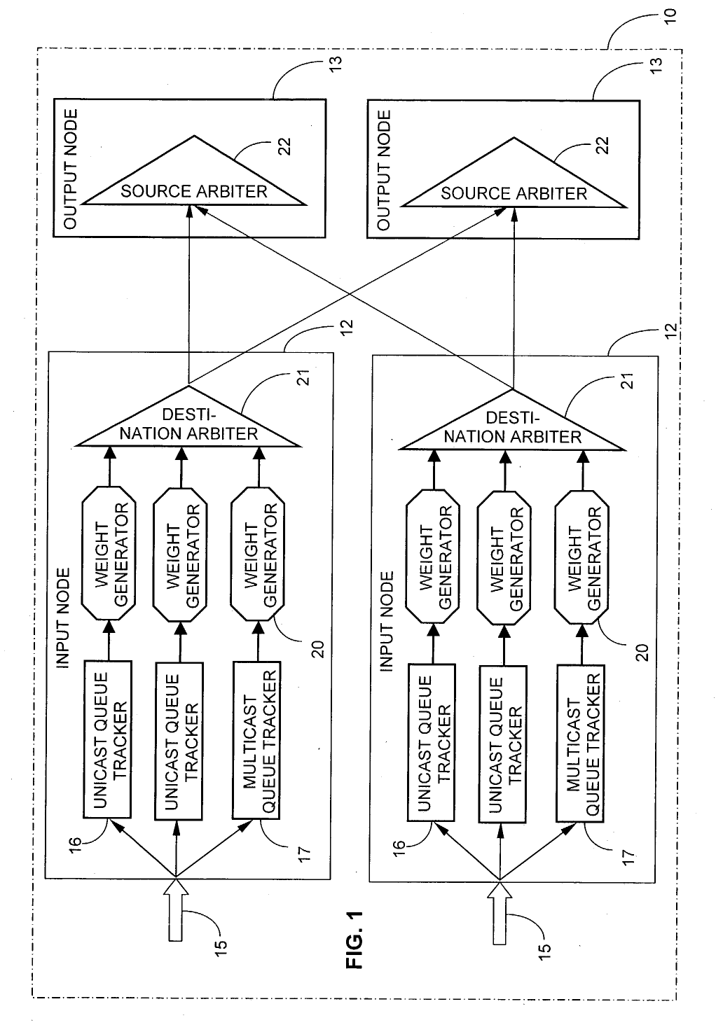

FIG. 1 shows a scheduler 10 according to the invention for scheduling unicast and multicast data cells. The scheduler 10 comprises N input nodes 12 and M outputs nodes 13. The scheduler 10 may have any number of input nodes and output nodes, but for the sake of simplicity, is illustrated with N=2 and M=2.

Each input node 12 receives a stream of data 15 regarding arrivals of unicast or multicast data cells to that node. Arrival data of a unicast data cell contains destination identifier (output node) and QoS (priority) value. Arrival data of a multicast cell contains identifiers of a group of destinations and QoS. There may be different QoS classes for multicast queues as well. In a preferred embodiment the group of destinations is identified by a bit map. The bit map includes a bit for each output node, where the value of a bit indicates whether a copy of the multicast cell is to be transmitted to that output node. However, in alternative embodiments, different group destination identifiers may be used.

Each input node 12 contains unicast queue trackers 16 and multicast queue trackers 17. Each queue tracker correlates to a specified VOQ, such that there are equal number of queue trackers as there are VOQs. In the preferred embodiment, each unicast queue tracker keeps track of the occupancy of the queue that it represents. The occupancy is equal to the number of cells that have arrived at the queue minus the number of cells that have departed from the same queue. The multicast queue tracker also keeps track of the occupancy of the multicast queue that it represents, where each multicast arrival contributes F arrivals to the occupancy, where F denotes the multicast cell fan-out (number of asserted bits in the multicast bit map). However, in alternative embodiments, a different method of tracking the queues'states may be used.

Each queue tracker 16/17 is informed of arrival data from the data stream 15 to the VoQ that it keeps track of. Each input node 12 contains weight generators 20, each coupled to a single queue tracker 16/17 and generating weights according to data that it receives from its associated queue tracker. In the preferred embodiment, the weight generator 20 follows the approach described in Reference [8], which provides an expression of statistical queuing metrics such as average waiting time, QoS criterion and occupancy. However, in alternative embodiments, a different discipline of weight generation may be used. Thus, for example, the weight generator can simply forward the occupancy of the queue, as it receives it from the queue tracker, in which case the weight generator takes no active role. In this way, the higher the occupancy of the queue is, the higher is its weight.

Each input node 12 contains a destination arbiter 21 coupled to each of the weight generators 20. The destination arbiter 21 compares the weights of the different weight generators 20 and determines which weight generator holds the highest value. The destination arbiter 21 sends only the highest weight to that output node 13 that is coupled to the weight generator (VOQ) of the highest value.

Each output node 13 contains a source arbiter 22 that receives weights from a sub set of the input nodes 12 corresponding to all the input nodes whose highest weight queues are determined by their respective destination arbiter 21 to be destined to that output node 13. The source arbiter compares the weights of the different input nodes 12 and determines which input node 12 holds the highest value. This input node 12 is granted by the output node 13 and these two nodes are scheduled for switching.

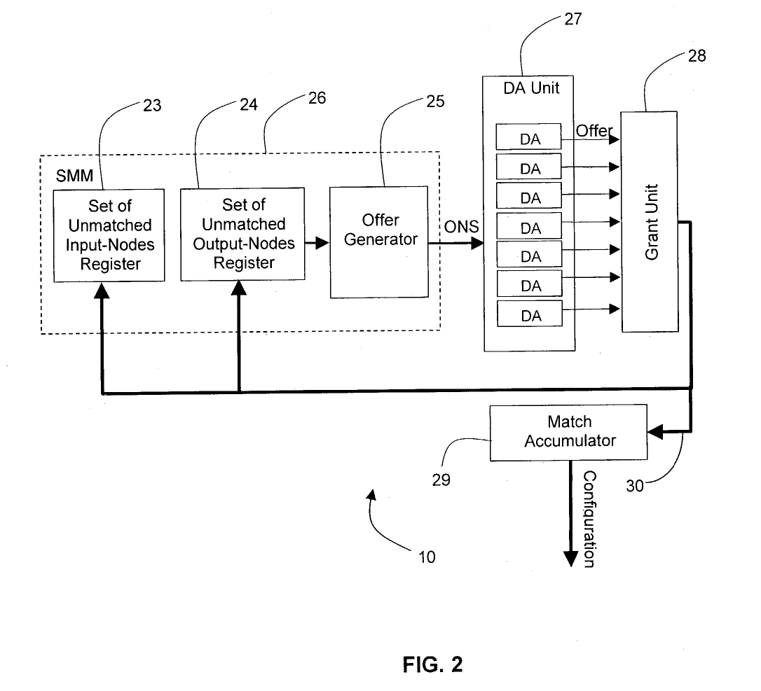

FIG. 2 shows functionally the scheduler 10. Registers 23 and 24 store a set of unmatched input-nodes and a set of unmatched output-nodes, respectively. The register 24 is coupled to an offer generator 25 that selects a subset of available (i.e. unmatched) output-nodes in respect of which unmatched inputnodes are to be selected. The registers 23 and 24 together with the offer generator 25 constitute a scheduling management module 26, which thus generates a subset of the unmatched output-nodes referred to as the “Offered Nodes Set” (ONS) over which to contend. The ONS may be derived by randomly selecting a sizelimited subset of the available (i.e. unmatched) output-nodes. Alternatively, the subsets may be selected in a sequential manner out of the set of the available output-nodes.

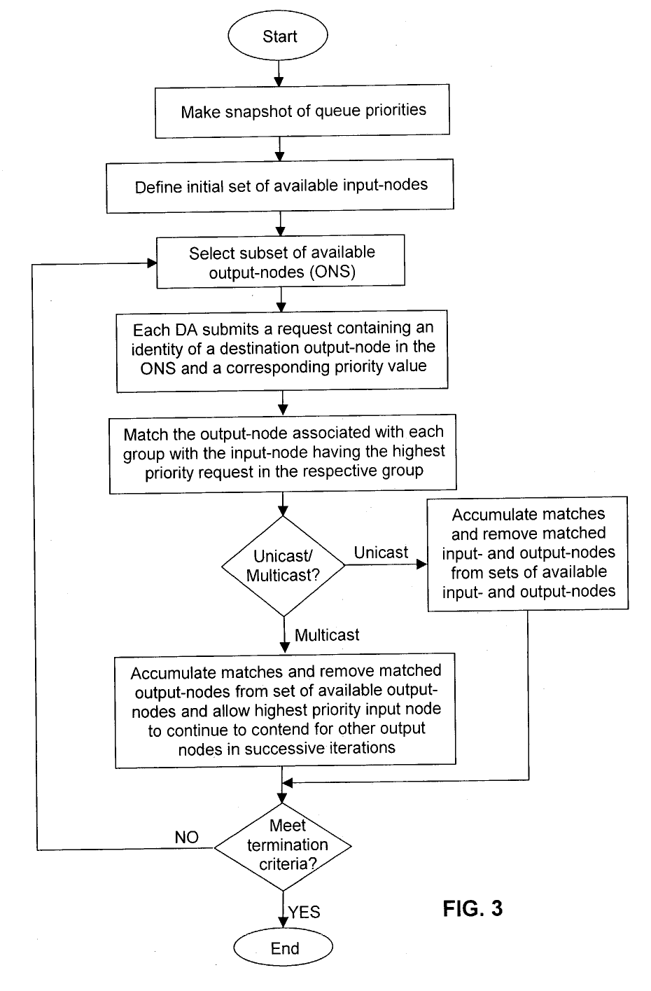

The ONS is fed to a DA Unit 27 being a collection of destination arbiters (DAs) 22, each associated with a respective input-node in the switch and described in further detail below with reference to FIG. 3 of the drawings. The output from all DAs 22 may be partitioned into groups, each containing all offers made by input-nodes for one specific output-node. Since offers can only be made for members of the ONS, the number of such groups cannot exceed the number of members in the ONS.

Although not limited to such a queuing scheme, the packets are queued in a VOQ realization. In order to support QoS provisioning, each queue may be associated with both an output-node and a QoS class. The DA 22 maintains logging of coherent statistical data regarding the arrival of packets to each of the queues in the node. Such information includes, but is not limited to, the number of packets occupying each queue, their respective arrival times and an indication as to whether they are destined for a single output node (unicast) or for more than one output node (multicast). It is another task of each DA to associate with each queue a priority level, which is based on the logged statistical data, and is recalculated continuously or when needed. The priority generating mechanism should be kept identical in all DAs if global fairness is to be assured, although the manner in which priorities are determined is not itself a feature of the invention.

The offers are then passed to a Grant Unit 28, which examines the offered priorities for each output node and selects the offer having the highest priority. For a unicast queue, each offer corresponds to one known output-node (from the ONS), and the prevailing offer was made by one known input-node, thus allowing a match to be formed between these input- and output-nodes. For a multicast queue, the prevailing offer was made by one known input-node to one or more available output-node, thus allowing one or more matches to be formed between the input-node and one or more of these output-nodes. To these ends, a Match Accumulator 29 is responsively coupled to the Grant Unit 28 via a bus 30 bearing the respective identities of the matching input- and output-nodes.

Referring now to FIG. 3, there will be summarized the principal steps carried out by an algorithm executed by the scheduler 10. The matching of input-nodes with output-nodes is achieved by conducting a sequence of output-node contentions (iterations), in each of which unmatched input-nodes contend for a given subset of the unmatched output-nodes. At the end of each such iteration, input-output-node matches are established. These matches are accumulated to form a complete matching configuration at the end of the time slot.

In the first step of the algorithm, as noted above with reference to FIG. 2 of the drawings, each DA produces an “offer”, based on the ONS and on the queue priorities maintained inside that DA. This offer consists of (a) the index of one or more output-nodes, each of which must be a member of the ONS, whose corresponding queue within the DA has the highest priority value of all queues in the DA corresponding to members of the ONS; (b) the priority value associated with the corresponding queue.

The offers are grouped by the Grant Unit 28 according to output-node identity and the output-nodes associated with each offer are then concurrently matched with the input-node having the highest priority offer for the respective offer. For unicast queues, this results in a single output-node being matched with the highest priority input-node. For multicast queues, this may result in more than one available output-node being matched with the highest priority input-node The matches are accumulated and, for unicast queues, the matched input- and output-nodes are removed from the sets of available input- and output-nodes. For multicast queues, each matched output node is removed from the set of available output-nodes, but the matched input-node may continue to send requests for other output-nodes during successive iterations from the same multicast queue until the queued data has been sent to all of the output-nodes associated with the multicast queue. The procedure is now repeated, as required, for the new sets of available nodes until expiry of the current time slot.

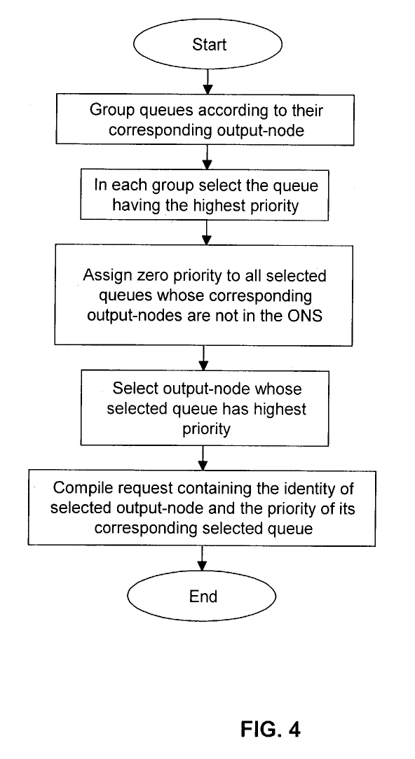

FIG. 4 shows a preferred algorithm for determining the offer to be submitted by a DA in the algorithm described above with reference to FIG. 3. First, queues are grouped according to their corresponding output-node, and in each group, the queue having the highest priority is selected. Then zero priority is assigned to all selected queues whose corresponding output-nodes are not in the ONS, and the output-node whose selected queue has the highest priority is selected. An offer is compiled containing the identity of the selected output-node and the priority of its corresponding selected queue.

It is possible for the invention to be applied to certain ‘blocking’ cross-connect fabrics in which the establishment of a channel may prevent (block) the establishment of further channels connecting nodes other than those connected by the established channel. If such a fabric is to be used, then upon the creation of a match and the allocation of the corresponding channel, the SMM will remove from both sets of available nodes those input- or output-nodes that were blocked by the allocated channel.

It is another task of the SMM to assure that the presented ONS's are in such composition and order to maximize efficiency and QoS provisioning.

An end-of-timeslot (EOTS) condition is determined by the SMM upon detecting the occurrence of any predetermined combination of events. The most preemptive such event is the ‘satisfaction’case in which for all unmatched input-nodes, the priority of all queues corresponding to the set of unmatched output-nodes is zero. In such an event further iteration can yield no more matches and the time slot must be terminated. To allow for the detection of this event, each DA provides the SMM with a signal or signals from which the SMM can infer a ‘satisfaction’condition in that DA.

Other examples of conditions that can be used by the SMM to determine an EOTS are: (a) exhaustion of cross-connect channels; (b) the duration of the time slot has exceeded a preset number of iterations or a preset amount of time; (c) the priorities of matches made during the time slot have accumulated to exceed a preset threshold, (d) a predetermined number of iterations; (e) an accumulated number of matches exceeds a predetermined threshold.

In the event of EOTS, the input-output-node matches accumulated during the time slot are passed to the cross-connect control circuitry, the sets of unmatched nodes are reset and a succeeding time slot is initiated.

The above technique may employ a pipelined implementation to accelerate the matching process (shortening time-slot duration). In this manner, different stages of the algorithm are carried out concurrently in separate stages of the architecture, with the output of a stage being fed to the input of its successor. Higher processing speed is gained at the expense of a constant latency derived from the pipeline stages.

The SMM can reduce the time slot duration by identifying output-nodes that are not offered by any input-node or by gathering statistical information based on which the Offered Nodes Sets are to be produced.

In the preferred embodiment, the algorithm performed by the scheduler performs the initialization steps of making a snapshot of queue priorities and defining sets of available input-nodes and available output-nodes each containing all input-nodes and output-nodes, respectively. However, it will be understood that the initialization can be performed independently such that the scheduler receives the snapshot and the sets of initially available input-nodes and available output-nodes. This can be used, for example, to shorten the time-slot duration by defining the sets of available nodes to initially contain only a (possibly random) subset of the nodes actually present in the switch.

Likewise, the processing of submitting one offer for each input-node may be performed for all input-nodes concurrently. So too matching the output-node associated with each group with the input-node having the highest priority offer in the respective group may be performed for all output-nodes in the ONS concurrently. Alternatively, these processes can be carried out in any desired serial manner.

The invention is also directed to an apparatus for real-time packet scheduling in high-rate, high port density, packet switched networks supporting QoS, comprising circuitry for locally determining packet scheduling at each input-node, according to information about priorities and available transmission resources at all other switch nodes which is collected over all said switch nodes in real-time.

The apparatus consists of a switch with a plurality of input-ports and output-ports, and switching control circuitry for controlling data transfer from input-ports to output-ports using assigned channels, and a cross-connect for the transmission of data through the channels. A scheduler controls the channel assignment process via designated control lines.

It will also be understood that the scheduler according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters and Roman numerals used to designate claim steps are provided for convenience only and do not imply any particular order of performing the steps.

1. A method for scheduling data packets transported from input-nodes to output-nodes said data packets being associated with a set of N input-nodes each having a plurality of M queues each for queuing data packets for routing to one or more corresponding M output-nodes, said method comprising:
(a) receiving sets of available input-nodes and available output-nodes which may contain all input-nodes and output-nodes, respectively;
(b) for each queue in the set of available input nodes generating a weight value reflecting the urgency of the specified queue to transmit its queued cells;
(c) determining a highest weight queue in each input node in the set of available input nodes being the queue with the highest weight;
(d) if the highest weight queue is a unicast queue, sending a request containing the weight of the queue to a single output node relating to the highest weight queue;
(e) if the highest weight queue is a multicast queue, sending a request containing the weight of the queue to one or more output nodes relating to the multicast queue;
(f) in respect of each output node receiving requests from one or more input nodes:
i) determining a highest weight input node being the input node having the highest weight queue of those input nodes from which a request was received;
ii) sending a grant to the highest weight input node;
iii) removing the output node from consideration in successive iterations;
iv) if the highest weight input node relates to a unicast queue, removing the highest weight input node from consideration;
v) if the highest weight input node relates to a multicast queue, allowing the highest weight input node to continue sending requests for other output nodes in successive iterations but only from said multicast queue; and
(g) repeating (b) to (f) as required.

2. The method according to any claim 1, wherein steps (b) to (f) are repeated for a predetermined number of iterations.

3. The method according to claim 1, wherein steps (b) to (f) are repeated for up to a predetermined time.

4. The method according to claim 1, wherein steps (b) to (f) are repeated until an accumulated value of the priorities of matched input-nodes exceeds a predetermined threshold.

5. The method according to claim 1, wherein steps (b) to (f) are repeated until an accumulated number of matches exceeds a predetermined threshold.

6. The method according to claim 1, wherein steps (b) to (f) are repeated until no more switching channels are available to be allocated.

7. The method according to claim 1, wherein steps (b) to (f) are repeated until a logical combination is satisfied relating to:
i) the priorities of all queues corresponding to the set of unmatched output-nodes are zero,
ii) a predetermined number of iterations,
iii) a predetermined time,
iv) an accumulated value of the priorities of matched input-nodes exceeds a predetermined threshold,
v) an accumulated number of matches exceeds a predetermined threshold , and
vi) no more channels of the switching fabric are available to be allocated.

8. The method according to claim 1, wherein in (a) a subset of available output-nodes is selected randomly to contain at most K output-nodes, where K is any integer between 1 and M.

9. The method according to claim 1, wherein in (a) a subset of available output-nodes is selected in a sequential manner to contain at least two output-nodes.

10. The method according to claim 1, wherein in (f) the highest priority request in the respective input-node is determined by:
i) grouping queues according to their corresponding output-node,
ii) in each group, selecting the queue having the highest priority,
iii) assigning zero priority to all selected queues whose corresponding output-nodes are not in the ONS,
iv) selecting the output-node whose selected queue has the highest priority, and
v) compiling a request containing the identity of the selected output-node and the priority of its corresponding selected queue.

11. A scheduler for scheduling data packets transported from input-nodes to output-nodes, said data packets being associated with a set of N input-nodes each having a plurality of M queues each for queuing data packets for routing to a corresponding one of M output-nodes, said scheduler comprising:
one or more unicast queue trackers associated with each input node for queuing data packets to be conveyed to a single output-node,
one or more multicast queue trackers associated with each input node for queuing data packets to be conveyed to more than one output-node,
a respective weight generator coupled to each unicast queue trackers and to each multicast queue trackers for determining a highest weight queue for the respective input node,
a destination arbiter associated with each input node coupled all of the weight generators associated with the respective input node for determining to which output node to route the highest weight queue from each input node,
a respective source arbiter associated with each output node for receiving a number of requests each from a respective destination arbiter and for determining which of those requests derives from the input node having the highest weight,
a grant unit coupled to the source arbiters for matching the output-node with the input-node having the highest priority request, and
a match accumulator coupled to the grant unit for accumulating matches and removing matched output-nodes from the set of available output-nodes and for removing from the set of available input-nodes matched input-nodes whose highest weight queue is a unicast queue.

12. The scheduler according to claim 11, further including an offer generator coupled to the available output-nodes register for selecting a subset (ONS) of the set of available output-nodes.

13. The scheduler according to claim 11, being adapted to:
(a) receive sets of available input-nodes and available output-nodes which may contain all input-nodes and output-nodes, respectively,
(b) for each queue in the set of available input nodes generate a weight value reflecting the urgency of the specified queue to transmit its queued cells,
(c) determine a highest weight queue in each input node in the set of available input nodes being the queue with the highest weight,
(d) if the highest weight queue is a unicast queue, send a request containing the weight of the queue to a single output node relating to the highest weight queue,
(e) if the highest weight queue is a multicast queue, send a request containing the weight of the queue to one or more output nodes relating to the multicast queue,
(f) in respect of each output node receive requests from one or more input nodes:
i) determine a highest weight input node being the input node having the highest weight queue of those input nodes from which a request was received,
ii) send a grant to the highest weight input node,
iii) remove the output node from consideration in successive iterations,
iv) if the highest weight input node relates to a unicast queue, remove the highest weight input node from consideration,
v) if the highest weight input node relates to a multicast queue, allow the highest weight input node to continue sending requests for other output nodes in successive iterations but only from said multicast queue, and
(g) repeat (b) to (f) as required.

14. The scheduler according to claim 11, being implemented in a packet scheduler for a communications network.

15. The scheduler according to claim 13, being implemented in a packet scheduler for a communications network.

16. The scheduler according to claim 11, being implemented in a multi-processor computer.

17. The scheduler according to claim 13, being implemented in a multi-processor computer.

18. A program storage device readable by machine, tangibly embodying a program of instructions executable by the machine to perform method steps for scheduling data packets transported from input-nodes to output-nodes said data packets being associated with a set of N input-nodes each having a plurality of M queues each for queuing data packets for routing to one or more corresponding M output-nodes, said method comprising:
(a) receiving sets of available input-nodes and available output-nodes which may contain all input-nodes and output-nodes, respectively;
(b) for each queue in the set of available input nodes generating a weight value reflecting the urgency of the specified queue to transmit its queued cells;
(c) determining a highest weight queue in each input node in the set of available input nodes being the queue with the highest weight;
(d) if the highest weight queue is a unicast queue, sending a request containing the weight of the queue to a single output node relating to the highest weight queue;
(e) if the highest weight queue is a multicast queue, sending a request containing the weight of the queue to one or more output nodes relating to the multicast queue;
(f) in respect of each output node receiving requests from one or more input nodes:
i) determining a highest weight input node being the input node having the highest weight queue of those input nodes from which a request was received;
ii) sending a grant to the highest weight input node;
iii) removing the output node from consideration in successive iterations;
iv) if the highest weight input node relates to a unicast queue, removing the highest weight input node from consideration;
v) if the highest weight input node relates to a multicast queue, allowing the highest weight input node to continue sending requests for other output nodes in successive iterations but only from said multicast queue; and
(g) repeating (b) to (f) as required.

19. A computer program product comprising a computer useable medium having computer readable program code embodied therein for scheduling data packets transported from input-nodes to output-nodes said data packets being associated with a set of N input-nodes each having a plurality of M queues each for queuing data packets for routing to one or more corresponding M output-nodes, said computer program product comprising:
computer readable program code for causing the computer to receive sets of available input-nodes and available output-nodes which may contain all input-nodes and output-nodes, respectively,
computer readable program code for causing the computer to generate a weight value reflecting the urgency of a specified queue to transmit its queued cells for each queue in the set of available input nodes;
computer readable program code for causing the computer to determine a highest weight queue in each input node in the set of available input nodes being the queue with the highest weight;
computer readable program code for causing the computer to send a request containing the weight of the queue to a single output node relating to the highest weight queue if the highest weight queue is a unicast queue;
computer readable program code for causing the computer to send a request containing the weight of the queue to one or more output nodes relating to the multicast queue if the highest weight queue is a multicast queue;
computer readable program code for causing the computer to receive requests from one or more input nodes in respect of each output node;
computer readable program code for causing the computer to determine a highest weight input node being the input node having the highest weight queue of those input nodes from which a request was received;
computer readable program code for causing the computer to send a grant to the highest weight input node;
computer readable program code for causing the computer to remove the output node from consideration in successive iterations;
computer readable program code for causing the computer to remove the highest weight input node from consideration if the highest weight input node relates to a unicast queue;
computer readable program code for causing the computer to allow the highest weight input node to continue sending requests for other output nodes in successive iterations but only from said multicast queue if the highest weight input node relates to a multicast queue.
